(19) United States
(12) Patent Application Publication
(10) Pub. No.: US 2016/0048688 A1
(43) Pub. Date: Feb. 18, 2016

(54) Restricting System Calls using Protected Storage

(71) Applicant: Google Inc., Mountain View, CA (US)

(72) Inventors: Andrew Flynn, Palo Alto, CA (US); Shishir Kumar Agrawal, Sunnyvale, CA (US); Simon Arscott, San Francisco, CA (US); Lawrence Jonathan Brunsman, Mountain View, CA (US)

(21) Appl. No.: 14/459,417

(22) Filed: Aug. 14, 2014

(51) Int. Cl. G06F 21/60; G06F 21/62

(52) U.S. Cl. CPC G06F 21/602; G06F 21/6218

(57) ABSTRACT

Systems and techniques are provided for restricting system calls using protected storage. A system call to a restricted system component may be received from an application. The application may be determined to have permission to make the system call to the restricted system component. A signature associated with the application may be verified using a public key from a protected storage. The public key may be sent to the protected storage by a computing device of a party authorized to modify data in the protected storage. The restricted system component may be permitted to perform a function indicated by the system call when the public key successfully verifies the signature associated with application.

### BACKGROUND

The operating system of a mobile computing device, such as a smartphone or tablet, may allow third parties to interact with various aspects of the operating system and applications which may be part of the operating system build through Application Programming Interfaces (APIs). Many of the APIs used on a mobile computing device may be considered safe, and third party applications installed on the mobile computing device may be able to use these APIs without requesting permission. Certain APIs, for example, APIs that allow for access to a component of the operating system or application responsible for receiving SMS messages on the mobile computing device, may be more sensitive. Third party applications may need to request permission from a user of the mobile computing device, for example, during the installation process, to access these APIs. The user may decide whether or not to grant permission to the third party application, allowing the user to prevent some applications from accessing certain functions of the mobile computing device. For example, a third party SMS messaging application may require the use of APIs in order to access incoming SMS messages and send outgoing SMS messages. The user may decide whether to allow the third party SMS messaging the use of these APIs during installation of the application.

Some APIs may be considered too dangerous to allow the user of the mobile computing device to control which third party applications may access them. These restricted APIs may only be accessible to applications installed in a privileged section of the system partition of the mobile computing device. The applications in the privileged section may need to be installed during the initial setup of the operating system on the mobile computing device. For example, a manufacturer of smartphones may create a system build that includes the operating system, platform components, and applications, which may all be installed on a smartphone as part of the manufacturing process, or later on when the operating system is updated. The applications installed as part of the system build may be system applications, and may have access to the restricted APIs that third party applications are not allowed to access. It may difficult to allow a third party application installed after the build has been installed to access these restricted APIs. Only the party responsible for the system build, for example, the manufacturer of the smartphone, may be able to install system applications, as they may only be installed as part of the system build.

### BRIEF SUMMARY

According to an embodiment of the disclosed subject matter, a system call to a restricted system component may be received from an application. The application may be determined to have permission to make the system call to the restricted system component. A signature associated with the application may be verified using a public key from a protected storage. The public key may be sent to the protected storage by a computing device of a party authorized to modify data in the protected storage. The restricted system component may be permitted to perform a function indicated by the system call when the public key successfully verifies the signature associated with application.

The restricted system component may be a restricted API. The SIM card may include the protected storage. The public key may be received from the computing device of the party authorized modify data in the protected storage. The public key may be received via an out-of-band over-the-air update. The signature associated with the application may be created using a private key from a public/private key pair. The public key may be part of the public/private key pair. The computing device of the party authorized to modify data in the protected storage may be used to create the signature associated with the application using the private key. The party authorized to modify data in the protected storage may be a cellular service provider. The function indicated by the system call may be one of SMS filtering, dialing an emergency number, erasing a storage, and changing a network access setting.

A second system call to the restricted system component may be received from a second application. The second application may be determined to have permission to make the system call to the restricted system component. A second signature associated with the application may be verified using a public key from a protected storage. The public key may have been sent to the protected storage by a computing device of a party authorized to modify data in the protected storage. The restricted system component may be prevented from performing a function indicated by the second system call when the public key fails to verify the second signature associated with second application. The second signature may be created using a private key that is not part of the same public/private key pair as the public key from the protected storage.

Before permitting the restricted system component to perform a function indicated by the system call when the public key successfully verifies the signature associated with application, the name of the application may be verified as being on a list of unique package names in the protected storage. The restricted system component may be prevented from performing the function if the verification fails or the restricted system component may be permitted to perform the function if the verification succeeds.

According to an embodiment of the disclosed subject matter, a means for receiving a system call to a restricted system component from an application, a means for determining that the application has permission to make the system call to the restricted system component, a means for verifying a signature associated with the application using a public key from a protected storage, wherein the public key was sent to the protected storage by a computing device of a party authorized to modify data in the protected storage, a means for permitting the restricted system component to perform a function indicated by the system call when the public key successfully verifies the signature associated with application, a means for receiving the public key from the computing device of the party authorized modify data in the protected storage, a means for receiving a second system call to the restricted system component from a second application, a means for determining that the second application has permission to make the system call to the restricted system component, a means for verifying a second signature associated with the application using a public key from a protected storage, wherein the public key was sent to the protected storage by a computing device of a party authorized to modify data in the protected storage, a means for preventing the restricted system component from performing a function indicated by the second system call when the public key fails to verify the second signature associated with second application, a means for before permitting the restricted system component to perform a function indicated by the system call when the public key successfully verifies the signature associated with application, verifying that the name of the application is on a list of unique package names in the protected storage, and a means for preventing the restricted system component from performing the function if the verification fails or permitting the restricted system component to perform the function if the verification succeeds, are included.

A means for a means for generating a public/private key pair including a public and private key, wherein the public key verifies a signature created using the private key, a means for generating a certificate including the signature created using the private key, a means for signing an application with the certificate, a means for sending the application to be installed on a mobile computing device, a means for sending a copy of the public key to be stored in a protected storage of the mobile computing device, a means for generating a second public/private key pair including a second public and a second private key, wherein the second public key verifies a second signature created using the second private key, a means for deleting the public key from the protected storage of the mobile computing device, a means for removing the certificate from the application, a means for generating a second certificate including the second signature, a means for signing the application with the second certificate to generate an updated application, a means for sending the updated application to the mobile computing device to replace the application, and a means for sending a copy of the second public key to the protected storage of the mobile computing device, are also included.

Systems and techniques disclosed herein may allow for restricting system calls using protected storage. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for restricting system calls using protected storage according to an implementation of the disclosed subject matter.

FIG. 2 shows an example arrangement for restricting system calls using protected storage according to an implementation of the disclosed subject matter.

FIG. 3 shows an example of a process for restricting system calls using protected storage according to an implementation of the disclosed subject matter.

FIG. 4 shows an example of a process for restricting system calls using protected storage according to an implementation of the disclosed subject matter.

FIG. 5 shows an example of a process for restricting system calls using protected storage according to an implementation of the disclosed subject matter.

FIG. 6 shows a computer according to an embodiment of the disclosed subject matter.

FIG. 7 shows a network configuration according to an embodiment of the disclosed subject matter.

### DETAILED DESCRIPTION

Restricting mobile systems calls using a Subscriber Identity Module (SIM) may allow for applications installed on a mobile computing device that were not part of the system build to access Application Programming Interfaces (APIs) and make system calls that may otherwise be prohibited. A mobile computing device may include an operating system, which may include a number of restricted APIs that allow access to various sensitive functions of the operating system and related components of the operating system's platform. Restricted API's may be accessible to applications installed as part of a system build, for example, by a manufacturer of the mobile computing device. To allow an application from a third party, for example, a cellular service provider, access to a restricted API, the application may be signed by the third party with a certificate using the private key from a public/private key pair. The application may be installed on the mobile computing device, and may request, during the installation process, permission to access the restricted API. The user may choose to grant the request. The third party may transfer the public key from the public/private key pair to a protected storage on the mobile computing device which the third party is authorized, and may have the exclusive ability, to modify. For example, a cellular service provider may transfer the public key certificate to secure certificate storage on Subscriber Identity Module (SIM) card on the mobile computing device. When the application is run on the mobile computing device and makes a system call to the restricted API, the operating system of the mobile computing device may use the public key from the protected storage to verify the private key signature in the application's certificate. If the verification is successful, the application may be permitted to call the restricted API. The restricted API may then perform whichever function was requested by the system call from the application.

A mobile computing device, such as, for example, a smartphone or tablet, may run an operating system that is part of a mobile platform. The operating system may include APIs and other system components allowing for other applications on the mobile computing device to access functions and data controlled by the operating system. Some of the system components may be restricted system components, such as restricted APIs. The restricted APIs in an operating system may be related sensitive data and functions. It may be a security risk to allow any third party application installed on the mobile computing device to make system calls to restricted APIs. For example, a restricted API may include a function that can erase the storage of the mobile computing device when activated. Another restricted API may control access to various telephony-related functions and data, such as, for example, SMS message filtering, calling emergency phone numbers, and viewing and changing network access settings used to access a cellular service provider's network. An application without proper permissions that makes a system call to a restricted API may be denied access to the restricted API. For example, a third party application installed on a mobile computing device but is not part of the system build may attempt to call a restricted API to erase the storage of the mobile computing device, wiping out all of the data stored on the mobile computing device. The operating system, is response to the receiving the system call from the third party application, may throw a security exception, preventing the third party application from using the storage erasure function of the restricted API.

A third party may want to make available an application that has access to a restricted API and that can be installed on the mobile computing device after the system build has already been installed. For example, a smartphone may have its system build, including application that have access to restricted APIs, installed by the smartphone's manufacturer. The smartphone may later be activated for use with a cellular service provider. The cellular service provider may wish to allow its users to install an application on the smartphone that can access certain restricted APIs. Because the cellular service provider did not create the system build, and may not be responsible for future system builds for the smartphone, the cellular service provider may be unable to have its application installed as part of the system build. The cellular service provider may also not wish to wait for future system builds to allow for the installation of applications with access to restricted APIs that are not part of the current system build.

The third party may create an application that the third party would like to have access to a restricted API on the mobile computing device, and sign the application with a certificate using the private key from a public/private key pair. The public/private key pair may be generated in any suitable manner, using any suitable cryptographic techniques, systems, and algorithms. The private key may be known only to the third party, and may be held in secret to prevent any other party from obtaining the key to sign applications. When the application is downloaded and installed to the mobile computing device, the user of the mobile computing device may be requested to grant the application permission to access the restricted API. The application may only be installed if the user grants the requested permission. For example, a cellular service provider may create an application that uses a restricted telephony API of the operating system of a smartphone to read and write to settings that control network access by the smartphone. A user may download and install the application to their smartphone in any suitable manner, such as, for example, through an application ecosystem storefront, through a storefront provided by the cellular service provider, or by downloading and sideloading the application outside of an online storefront. An example of sideloading includes transferring applications and/or data between two local devices, such as between a computer and a mobile device such as a mobile phone, smartphone, PDA, tablet, portable media player or e-reader, or between two mobile devices.

During the installation process, the application may indicate to the operating system of the smartphone that the application requires permission to access the restricted telephony API. The operating system may present the user with a dialogue, allowing the user to grant the application permission to access, and make system calls to, the restricted telephony API. The permission granted by the user may apply only to selected system calls for restricted APIs, as requested by the application. For example, the application may only request, and be granted, permission to use a subset of system calls from a restricted API, and may not have permission to access system calls from that restricted API outside of the subset for which permission was requested and granted.

The third party responsible for creating the application signed with the private key may be authorized, and may also be exclusively be able, to modify a protected storage on the mobile computing device. The protected storage may be any suitable storage, such as, for example, certificate storage on a SIM card. For example, a cellular service provider for a smartphone may be the only party with the ability to store and modify data in the certificate storage on a SIM card in the smartphone. The third party may send the public key from the public/private key pair to be stored in the protected storage of the mobile computing device. For example, the cellular service provider may perform an over-the-air (OTA) transmission of the public key to the certificate storage of the smartphone's SIM card, out-of-band from normal OTA system updates. The third party may send the public key to the protected storage of the mobile computing device at any suitable time. For example, a cellular service provider may store the public key in smartphone SIM card's certificate storage when the application is created by the third party in anticipation of future installation by the smartphone's user, at the time the application in installed on the smartphone, when the application is first-run on the smartphone, or when the application attempts to make its first call to a restricted API of the smartphone's operating system. The public key may include an indication of which applications the public key may be used to verify.

The application from the third party may be run on the mobile computing device, and may make a system call to the restricted API. Before the operating system performs the function, or allows the application access to data, associated with the system call to the restricted API, the operating system may attempt to verify the permissions and signature of the application. The operating system may check to ensure that the application has been granted the proper permissions, for example, by the user during installation, to make the system call to the restricted API. If the application has proper permissions, the operating system may retrieve the public key from the protected storage and use the public to check the signature in the certificate of the application, otherwise, if the application does not have the proper permissions, the application may have access to the restricted API denied. The verification may use any suitable cryptographic technique, such as, for example, any verification technique associated with the manner in which the public/private key pair was generated. If the signature is verified using the public key, indicating the application was signed with the private key that matches the public key from the protected storage, the operating system may perform the function requested by the system call to the restricted API. If the signature is not verified, or there is no public key for the application in the protected storage, the application may be denied access to the restricted API. Lack of a public key may indicate that the proper public key has not yet been sent to the protected storage by the third party, or that the application was created by a party that does not have the ability to modify the protected storage.

For example, an application that adjusts network access settings may be installed on a smartphone, and the user may grant the application permission to make system calls to the restricted telephony API of the smartphone's operating system. The application may be have been created by the cellular service provider for the smartphone, and may be signed with a certificate using a private key held in secret by the cellular service provider. The cellular service provider may then send the corresponding public key to the certificate storage of the smartphone's SIM card. The application may be run, and may make a system call to the restricted telephony API to change one of the network access settings. The operating system may first check that the application was granted permission to make the system call to the restricted API activating a function that writes changes to the network access settings. If the permissions were granted, the operating system may retrieve the public key from the protected storage and use the public key to verify the signature in the certificate of the application. Because the public key corresponds to the private key used to sign the application, the public key may verify the signature of the application. The operating system may then allow the restricted API to perform the function requested by the system call, writing the specified changes to the network access settings.

Because the third party may hold the private key in secret, and may be the only party that can modify the protected storage, only applications created and signed by the third party may access restricted APIs on a mobile computing device. An application created by any other party may be denied access to the restricted APIs. A fourth party application may not be signed with a certificate using any private key, in which case any attempt by the operating system to verify the signature on the application in response to a system call to a restricted API would fail, resulting in a denial of access to the restricted API. A fourth party application may be signed with a certificate using a private key, however, because the private key used by the third party is held in secret, the private key used by the fourth party may not be the same as the private key used by the third party. Any public key sent to the protected storage by the third party may fail to verify the signature on an application from the fourth party, as the private key used to sign the fourth party application may not be from the third party public/private key pair. A fourth party may be unable to send its own public into the protected storage to be used to verify fourth party applications, as the fourth party may not be able to modify the protected storage. This may allow a party that is authorized to modify the protected storage of a mobile computing device to create applications that make system calls to restricted APIs and have those applications installed outside of a system build.

For example, an application developer that is not related to the cellular service provider for a smartphone may create an application that calls a restricted API that includes a function to erase the storage of the smartphone. The application may be signed with a certificate using a private key from a public/private key pair generated by the application developer. The user may install the application, and may grant the application permission to access the restricted API. When the application is run, the application may make a system call to the restricted API to activate the function that will erase the storage of the smartphone. The operating system may determine that the application has the proper permissions to make the system call, and then may attempt to verify the signature in the certificate of the application. The SIM card of the smartphone may have public key stored in certificate storage. The public key may have been part of a public/private key pair generated by the cellular service provider, and may have been sent to the certificate storage of the SIM card by the cellular service provider. The application developer may not have the private key generated by the cellular service provider. The operating system may use the public key from the SIM card to attempt to verify the signature of the certificate of the application developer's application. Because the application was signed with a private key from a different public/private key pair than the public key stored on the SIM card, that verification attempt may fail, and the application may be prevented from erasing the storage of the smartphone using the function of the restricted API. The application developer may have no ability to store its own public key on the SIM card. This may make it impossible for the application developer to get the operating system to verify its application and allow the system call to the restricted API without the cooperation of the cellular service provider, as only the cellular service provider may store public keys on the SIM card. In this way, access to the restricted APIs of the smartphones operating system is limited to application installed by the system builder, and applications approved by the cellular service provider whose SIM card is in the smartphone.

The same public/private key pair may be used for multiple installations of the same application, and for multiple different applications, from the same third party. For example, a cellular service provider may create an application and sign all copies of the application with the same private key, and send a copy of the same public key to every mobile computing device on which the application is installed. Different public/private key pairs may also be used for multiple installations of the same application, or for multiple different applications, from the same third party. For example, a cellular service provider may create three public/private key pairs, and use each public/private key pair with a different application, or with some number of the multiple installations of the same application.

The public/private key pair used by the third party may be replaced if necessary. For example, the third party may employ key rotation or the private key may be leaked or stolen and become available to the public. The third party may generate a new public/private key pair and may remove the old public key from the protected storage of any mobile computing device it's on, replacing it with the new public key. A new build of the application may be signed with the new private key, and users may be asked to update the version of the application installed on their mobile computing devices. The application may not be able to access restricted APIs until it is updated, as the new public key may result in failure when verifying an application signed using the old private key. Further, any application attempting to use the leaked or stolen private key may also be prevented from accessing the restricted API due to the new public key not verifying a signature made using the old private key.

In addition to the public key, a list of unique package names may also be stored in the protected storage. The list of unique package names may identify which of the third party applications may be allowed to access restricted APIs. The third party may send the list of unique package names to the protected storage in the same manner as the public key. When an application makes a call to a restricted API, the operating system may check the list of unique package names to determine if the application is identified, for example, has a name that is on the list of unique package names, in addition to verifying the applications signature with the public key. This may allow for further restriction of the applications which may make system calls to restricted APIs, as the third party may add names of applications to or revoke names from the list of unique package names. For example, the third party may revoke an application name from the list of unique package names, preventing that application from making system calls to restricted APIs even when that application was signed with the private key that was part of the public/private key pair with the public key in protected storage.

The functionality of the restricted APIs that may be used by an application may be limited. For example, a party for responsible for creating, distributing, or maintaining the operating system and platform of the mobile computing device may specify which restricted APIs, and which functionality, may and may not be accessed by application created by the third party. This may allow certain restricted APIs and certain functionality to remain inaccessible to any application not installed as part of the system build.

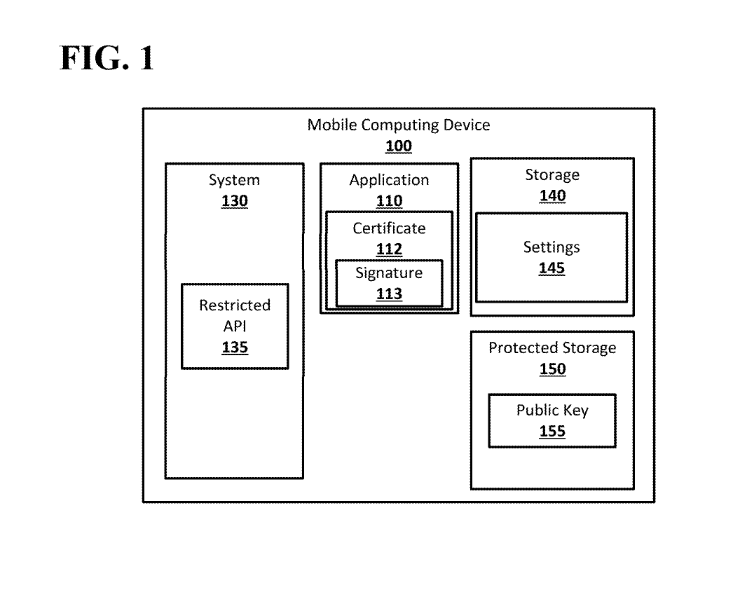

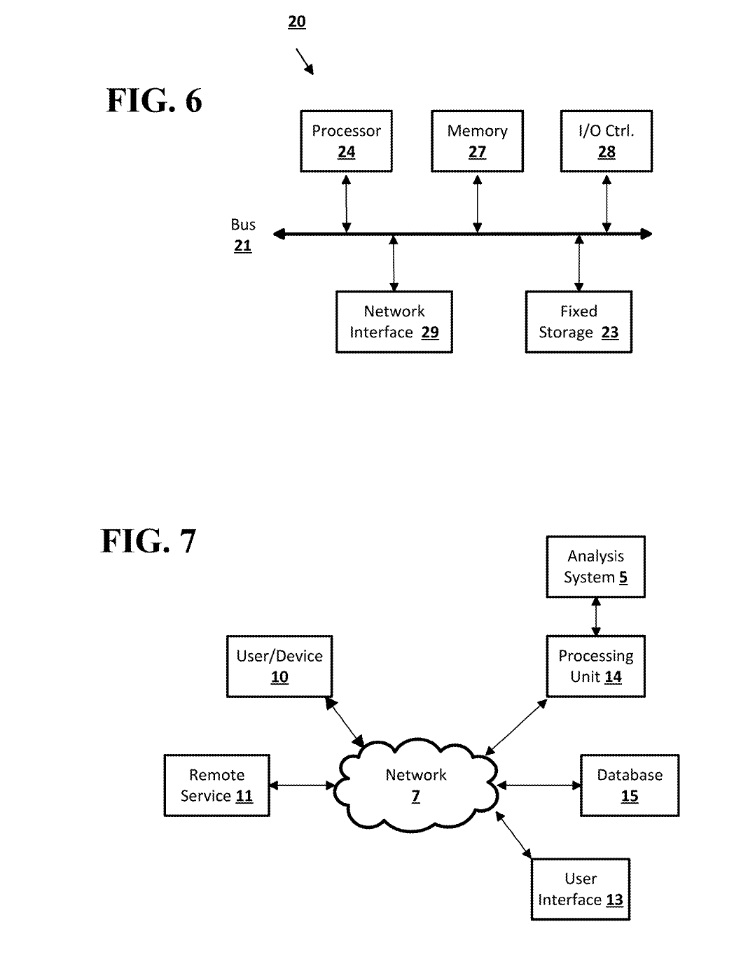

FIG. 1 shows an example system suitable for restricting system calls using protected storage according to an implementation of the disclosed subject matter. A mobile computing device 100 may include an application 110, a system 130, a storage 140, and a protected storage 150. The mobile computing device 100 may be any suitable device, such as, for example, a computer 20 as described in FIG. 6, for implementing the application 110, the system 130, the storage 140, and the protected storage 150. The mobile computing device 100 may be a single computing device, or may include multiple connected computing devices, and may be, for example, a mobile computing device, such as a tablet or smartphone, running a mobile operating system that may be part of a mobile platform. The system 130 may include the operating system of the mobile computing device 100, including restricted APIs such as the restricted API 105, and other component of the platform of the operating system, such as applications installed as part of the system build. The application 110 may be any suitable application that may be installed and run on the mobile computing device 100, and may be an application that was not part of the system build. The application 110 may include a certificate 112, which may include a signature 113. The storage 140 may store the settings 145 in any suitable manner. The protected storage 150 may store the public key 155 in any suitable manner.

The system 130 may include the operating system of the mobile computing device 100, along with any other components associated with and installed alongside the operating system. For example, the system 130 may be installed on the mobile computing device 100 as a system build, and may include an operating system, enhancements or modifications to the operating system, components that are part of the operating system's platform, and applications that may be installed on a system-privileged partition of the storage 140 of the mobile computing device 100. The system 130 may include various APIs, some of which may be restricted APIs such as the restricted API 135. The restricted API 135 may be an API to which the party responsible for the operating system of the system 130 has chosen to restrict access. Other components of the system 130, including the operating system and applications on the system-privileged partition, may be able to access and use the functionality of the restricted API 135, but other components of the mobile computing device 100 may be denied access to the restricted API 135 without proper credentials. For example, the application 120 may be unable access the restricted API 135.

The application 110 may be any suitable application that may be installed and run on the mobile computing device, and may include the certificate 112. The application 110 may be an application created and distributed by a third party. During installation, the application 110 may request, using any suitable mechanisms of the system 130, that the user of the mobile computing device 100 grant the application 110 permission to make system calls that use certain function of the restricted API 135. For example, the application 110 may request the permission to call a function of the restricted API 135 that dials an emergency number. The third party responsible for creating and distributing the application 110 may also be authorized, and may have the exclusive ability, to write to the protected storage 150. The application 110 may include the certificate 112, which may include the signature 113. The signature 113 may be created using the private key of a public/private key pair, which may be generated by, for example, the party that created the application 110. The private key may be held in secret. The certificate 112 and signature 113 may be used to allow the application 110 make system calls to the restricted API 135. The application 110 may be, for example, an application created by a cellular service provider, signed with a private key from a public/private key pair generated by the cellular service provider using any suitable cryptographic system.

The protected storage 150 may be any suitable combination of hardware and software for implementing storage on the mobile computing device 100. For example, the protected storage 150 may the SIM card of a smartphone or tablet. The protected storage 150 may only be modifiable by the third party responsible for creating the application 110. For example, only the cellular service provider may be able to modify data stored in the protected storage 150. The public key 155 may be stored in the protected storage 150 by the third party with the exclusive ability to modify the protected storage 150. For example, the cellular service provider may send the public key 155 from the public/private key pair to be stored protected storage 150, which may be a SIM card issued by the cellular service provider. The public key 155 may be stored using, for example, an over-the-air data transfer to the protected storage 150. The public key 155 may be from the same public/private key pair as the private key used to create the signature 113 for the application 110.

The system 130 may be able to read the public key 155 from the protected storage 150. For example, when the application 110 makes a system call to the restricted API 135, the system 130 may read the public key 155 from the protected storage 150. The system 130 may use the public key 155 to attempt to verify the signature 113 in the certificate 112 of the application 110, to determine if the application 110 is permitted to make the system call to the restricted API 135. The public key 155 may be used to verify the signature 113 in any suitable manner, for example, using a cryptographic technique based on the cryptographic technique used to generate the public/private key pair of the public key 155 and the private key used to create the signature 113. The system call from the application 110 may be permitted, and the called function of the restricted API 135 may be performed, when the signature 113 is successfully verified with the public key 155, as this may indicate that the application 110 was created by the third party that also is authorized to modify the protected storage 150.

The settings 145 may include any suitable settings for the mobile computing device 100 that may not be modifiable without the use of a restricted API. For example, the settings 145 may be the network access settings for a cellular service provider's network. The settings 145 may be created as part of a system build, and stored in the storage 140 when the system build, including the system 130, is installed on the mobile computing device 100. The settings 145 may only be modifiable through the use of a restricted API, such as the restricted API 135, and may otherwise be read-only. The application 110 may be able to use the restricted API 135 to modify the settings 145, based on verification of the signature 113 with the public key 155 by the system 130 when the application 110 sends a system call to the restricted API 135.

For example, the settings 145 may network access settings for a cellular service provider's network. The cellular service provider may create the application 110 to be able to modify the settings 145. The application 110 may be signed using certificate 112 with signature 113, which may be created using the private key of a public/private key pair. When installed on the mobile computing device 100, for example, a smartphone, the application 110 may request permission from the user to access the restricted API 135, which may be the restricted API including the functions for modifying the network access settings in the settings 145. The user may grant the requested permission. The cellular service provider may send the public key 155, which may be from the same public/private key pair as the private key used to create the signature 113, to the protected storage 150, which may be a SIM card, of the mobile computing device 100. The application 110 may be run, and make a system call to the restricted API 135, requesting the implementation of a function to modify the network access setting in the settings 145. The system 130 may use the public key 155 to verify the signature 113 of the application 110. Because the public key 155 may be from the same public/private key pair as the private key used to create the signature 113, the application 110 may be verified, and the system call to the restricted API 135 may be allowed. The restricted API 135 may then implement the modification to the network access settings in the settings 145 as requested by the application 110. Because only the cellular service provider may store any public key in the protected storage 150, for example, the SIM card of the smartphone, only the cellular service provider may create an application that may be installed outside of the system build but still may use the restricted API 135 to modify the settings 145.

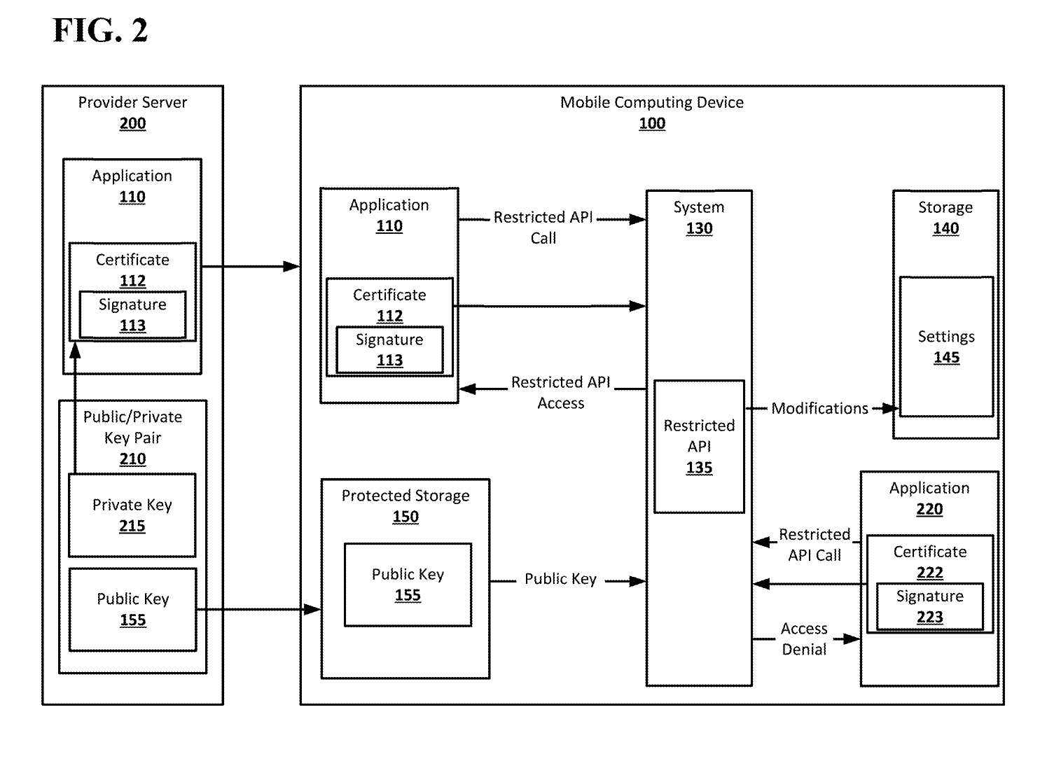

FIG. 2 shows an example arrangement for restricting system calls using protected storage according to an implementation of the disclosed subject matter. The application 110 may be created by a third party, for example, a cellular service provider, and stored on a provider server 200. The provider server 200 may be any suitable server system used by a third party such as a cellular service provider for creation and distribution of applications. The application 110 may be an application created to use functions of the restricted API 135 of the system 130.

A public/private key pair 210, including the public key 155 and the private key 215 may be generated by the provider server 200. The provider server 200 may use any suitable cryptographic technique to generate the public/private key pair 210, and the private key 215 may be held in secret, for example, stored securely on the provider server 200 and not exposed to public access. The private key 215 may be used to create the signature 113 in any suitable manner, and the signature 113 may be stored as part of the certificate 112. The certificate 112, with the signature 113, may be used to sign the application 110. The public key 155 may be sent from the provider server 200 to the protected storage 150 of the mobile computing device 100.

The application 110 may be downloaded and installed to the mobile computing device 100 in any suitable manner. For example, the application 110 may be downloaded directly from the provider server 200, from the storefront for an application ecosystem that may also be, for example, associated with the party responsible for creating the operating system of the system 130, or may be installed on the mobile computing device 100 by, for example, the party runs the provider server 200. For example, a cellular service provider may install the application 110 on all smartphone sold directly by the cellular service provider or activated for use on the cellular service provider's network. During installation, the application 110 may request that the user of the mobile computing device 100 grant the application 110 permission to use the functions of the restricted API 135. The user may grant the requested permission to the application 110.

The application 110 may be run on the mobile computing device 100. For example, the user may initiate the application 110, or the application 110 may be initiated on the startup of the mobile computing device 100 or in response to, for example, instructions received externally, for example, from the cellular service provider. The application 110 may make system call to the restricted API 135. For example, the application 110 may attempt to use a function of the restricted API 135 that changes network access settings stored in the settings 145.

The system 130 may receive the system call from the application 110 to the restricted API 135. The system 130 may determine that the application 110 was granted permission to make the system call, for example, because the user granted permission during the installation of the application 110. The system 130 may then retrieve the public key 155 from the protected storage 150, where the public key 155 was stored after being received from the provider server 200. The public key 155 may be used to attempt to verify the signature 113 in the certificate 112 of the application 110. Because the public key 155 was part of the public/private key pair 210, along with the private key 215 used to create the signature 113, the application 110 may be verified by the system 130.

The system 130 may allow the system call to the restricted API 135 to proceed after verifying the application 110, granting access to the restricted API 135 to the application 110. The restricted API 135 may perform whatever function was requested by the application 110 in the system call. For example, the restricted API 135 may be used to make requested modifications to the settings 145, which may be network access settings for the cellular service provider that runs the provider server 200.

Subsequent system calls from the application 110 to the restricted API 135 may require the system 130 to again verify the application 110 based on the public key 155 and the signature 113. The system 130 may also remember that the application 110 has been verified, and may permit the application 110 to make similar system calls to the system call that resulted in the original variation for some specified time period before again verifying the application 110.

The application 220 may be an application on the mobile computing device 100 that was not part of the system build, and was not created by the party that runs the provider server 200. For example, the application 220 may be an application from an application developer that is not associated with the cellular service provider that run the provider server 200. The application 220 may be signed using a certificate 222, with a signature 223. The signature 223 may have been created using a private key that was not the private key 215 from the public/private key pair 210.

The application 220 may make a system call to the restricted API 135. The system 130 may attempt to verify the application 220 based on the signature 223 in the certificate 222 using the public key 155. Because the signature 223 was created using a private key that was not the private key 215, the verification of the signature 223 with the public key 155 may fail. The system 130 may deny the application 220 access to the restricted API 135, for example, throwing a system error, and prevent the restricted API 135 from receiving the system call or performing the function requested by the system call. This may ensure that only applications which originate with the provider server 200 and are signed with the private key 215 can make system calls to the restricted API 135, as the party that runs the provider server 200 may be the party that is authorized, and may have the exclusive ability, to modify the protected storage 150 in order to store a public key, such as the public key 155, in the protected storage 150.

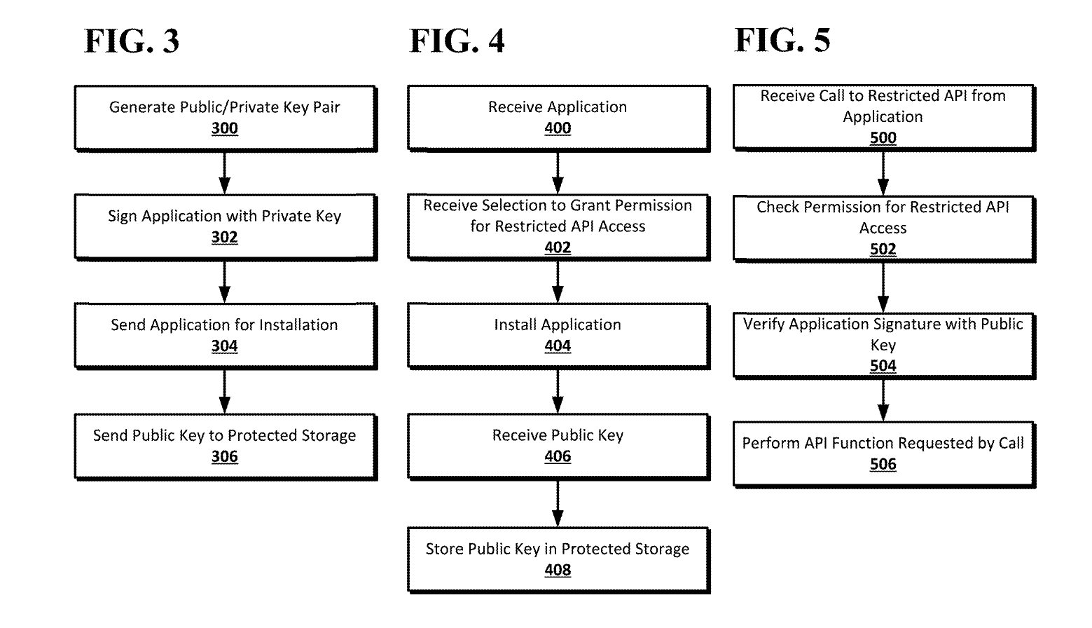

FIG. 3 shows an example arrangement for restricting system calls using protected storage according to an implementation of the disclosed subject matter. At 300, a public/private key pair may be generated. For example, a third party, such as a cellular service provider, may use any suitable cryptographic technique to generate the public/private key pair 210, including the public key 155 and the private key 215. The public/private key pair 210 may be stored, for example, on the provider server 200. The private key 215 may be stored securely, and may be held in secret to prevent its use by a party other than the third party running the provider server 200. The public/private key pair 210 may also be obtained in any other suitable manner. For example, a party responsible for the operating system in the system 130 may generate and securely the public/private key pair 210 to the provider server 200.

At 302, an application may be signed with the private key. For example, the application 110 may be created by the third party running the provider server 200. The application 110 may be signed with the certificate 112, which may include the signature 113 created using the private key 215 from the public/private key pair 210. The application 110 may be signed in any suitable manner, for example, at any suitable point during or after the creation of the application 110. The application 110 may include functionality that makes system calls to the restricted API 135.

At 304, the application may be sent for installation. For example, the application 110 may be sent from the provider server 200 directly to the mobile computing device 100 to be installed. The user of the mobile computing device 100 may initiate the downloading and installation of the application 110, or the application 110 may be installed by the third party, for example, a cellular service provider, while the third party has control of the mobile computing device 100, for example, before the mobile computing device 100 has been sold. The application 110 may also be sent to a storefront for an application ecosystem for distribution. For example, the party responsible for the operating system of the system 130 may include, as part of the platform for the operating system, an application ecosystem with a storefront. The application 110 may be downloaded and installed on the mobile computing device 100 from the storefront. The application 110 may also be side-loaded onto the mobile computing device 100.

At 306, the public key may be sent to protected storage. For example, the provider server 200 may transit a copy of the public key 155 directly to the mobile computing device 100, to be stored in the protected storage 150. The party running the provider server 200, for example, a cellular service provider, may be the only party with ability to modify and store data in the protected storage 150, which may be, for example, a SIM card issued by the cellular service provider. The public key 155 may be stored by the mobile computing device 100 in the protected storage 150. No other party may be able store any other public key in the protected storage 150, or remove the public key 155 from the protected storage 150. The public key 155 may be sent to the mobile computing device 100 at any suitable time. For example, the public key 155 may be sent after being generated, after the application 110 is installed on the mobile computing device 100, or after the application 110 makes a system call to the restricted API 135.

FIG. 4 shows an example arrangement for restricting system calls using protected storage according to an implementation of the disclosed subject matter. At 400, an application may be received. For example, the mobile computing device 100 may receive the application 110 from any suitable source, such as, for example, directly from the provider server 200, from a storefront for an application ecosystem associated with the operating system for the system 130, from a storefront for a different application ecosystem, or through a short range transfer, for example, via a USB or WiFi connection to a computing device that has a copy of the application 110 that can be side-loaded onto the mobile computing device 100.

At 402, a selection may be received to grant the application access to a restricted API. For example, the application 110 may be installed on the mobile computing device 100. During the installation, the application 110 may request, through the system 130, permission to access the restricted API 135. The user of the mobile computing device 100 may select to grant the permission, allowing the application 110 to send system calls to the restricted API 135. Permission may be requested and granted from multiple restricted APIs, and may also be limited to certain functions of different APIs. For example, the restricted API 135 may perform six functions, and the application 110 may only be granted permission to use three specific functions from those six functions.

At 404, the application may be installed. For example, the application 110 may complete installation on the mobile computing device 100 after being granted permission to access the restricted API 135. The application 110 may not install if permission was not granted, as the application 110 may not function properly without permission to access the restricted API 135.

At 406, a public key may be received. For example, the public key 155 may be received on the mobile computing device 100. The public 155 may be received through an out-of-band, over-the-air update sent from, for example, the provider server 200. The public key 155 may be received concurrent with the receiving of the application 110, during or after the installation of the application 110, or at any other suitable time.

At 408, the public key may be stored in protected storage. For example, the public 155 may be stored in the protected storage 150 of the mobile computing device 100. The public key may be received with instructions to store the public key in the protected storage 150, which may be, for example, a SIM card. The public key 155 may also be written directly to the protected storage 150, as the party running the provider server 200 may be able to directly address the protected storage 150 outside of the system 130. The party running the provider server 200, for example, a cellular service provider, may be the only party that may write to or modify the protected storage 150 on the mobile computing device 100.

FIG. 5 shows an example arrangement for restricting system calls using protected storage according to an implementation of the disclosed subject matter. At 500, a system call to a restricted API may be received from an application. For example, the system 130 may receive a system call to the restricted API 135 from the application 110. The application 110, running on the mobile computing device 100, may be attempting to use some functionality of the restricted API 135, such as, for example, erasing the storage 140, dialing an emergency number, performing SMS filtering, or writing to network access settings in the settings 145.

At 502, permission may be checked for restricted API access. For example, the system 130 may check to ensure that the application 110 has permission to make system calls to the restricted API 135, and to a make the particular system call that the application 110 is making The permission may have been granted during the installation of the application 110, for example, based on a selection made by the user.

At 504, a signature of the application may be verified with a public key. For example, the signature 113 in the certificate 112, used to sign the application 110, may be verified by the public key 155. The signature 113 may have been created using the private key 215, which be a part of the public/private key pair 210 along with the public key 155 that was generated on the provider server 200. The application 110 may have been signed with the private key 215 before distribution to the mobile computing device 100. The public key 155 may be retrieved from the protected storage 150 by the system 130, which may then use the public key 155 to verify the signature 113. The signature 113 may be verified because the signature 113 was created using the private key 215. This may ensure that only the party authorized to write to and modify the protected storage 150 can distribute applications that may be verified to access the restricted API 135. No other party may place their public key in the protected storage 150, so an application signed using a private key other than the private key 215 will not be verified, as the public key 155 will only verify a signature created using the private key 215. For example, a cellular service provider may be the only party that can store a public key on the SIM card of a smartphone. The cellular service provider may create and distribute applications that may use restricted APIs, signed with the cellular service provider's private key and verified using the matching public key stored by the cellular service provider on the smartphone's SIM card.

At 506, the API function requested by the system call may be performed. For example, the application 110 may have made a system call to the restricted API 135 to make changes to network access settings in the settings 145. The system 130 may use the restricted API 135 to implement the changes, as the application 110 has permission to use the restricted API 135 and was verified using the public key 155 from the protected storage 150.

Embodiments of the presently disclosed subject matter may be implemented in and used with a variety of component and network architectures. FIG. 6 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hhardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 7.

Many other devices or components (not shown) may be connected in a similar manner, such as document scanners, digital cameras, auxiliary, supplemental, or backup systems, or the like. Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 7 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

In situations in which the implementations of the disclosed subject matter collect personal information about users, or may make use of personal information, the users may be provided with an opportunity to control whether programs or features collect user information (e.g., a user's performance score, a user's work product, a user's provided input, a user's geographic location, and any other similar data associated with a user), or to control whether and/or how to receive instructional course content from the instructional course provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with an instructional course may be generalized where location information is obtained (such as to a city, ZIP code, or state level), so that a particular location of a user cannot be determined. Thus, the user may have control over how information is collected about the user and used by an instructional course provider.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
receiving a system call to a restricted system component from an application;
determining that the application has permission to make the system call to the restricted system component;
verifying a signature associated with the application using a public key from a protected storage, wherein the public key was sent to the protected storage by a computing device of a party authorized to modify data in the protected storage; and
permitting the restricted system component to perform a function indicated by the system call when the public key successfully verifies the signature associated with application.

2. The computer-implemented method of claim 1, wherein the restricted system component is a restricted API.

3. The computer-implemented method of claim 1, wherein a SIM card comprises the protected storage.

4. The computer-implemented method of claim 1, further comprising receiving the public key from the computing device of the party authorized modify data in the protected storage.

5. The computer-implemented method of claim 4, wherein the public key is received via an out-of-band over-the-air update.

6. The computer-implemented method of claim 1, wherein the signature associated with the application is created using a private key from a public/private key pair, and wherein the public key is part of the public/private key pair.

7. The computer-implemented method of claim 6, wherein the computing device of the party authorized to modify data in the protected storage is used to create the signature associated with the application using the private key.

8. The computer-implemented method of claim 1, wherein the party authorized to modify data in the protected storage is a cellular service provider.

9. The computer-implemented method of claim 1, wherein the function indicated by the system call is one of SMS filtering, dialing an emergency number, erasing a storage, and changing a network access setting.

10. The computer-implemented method of claim 1, further comprising:
receiving a second system call to the restricted system component from a second application;
determining that the second application has permission to make the system call to the restricted system component;
verifying a second signature associated with the application using a public key from a protected storage, wherein the public key was sent to the protected storage by a computing device of a party authorized to modify data in the protected storage; and
preventing the restricted system component from performing a function indicated by the second system call when the public key fails to verify the second signature associated with second application

11. The computer-implemented method of claim 10, wherein the second signature is created using a private key that is not part of the same public/private key pair as the public key from the protected storage.

12. The computer-implemented method of claim 1, further comprising:
before permitting the restricted system component to perform a function indicated by the system call when the public key successfully verifies the signature associated with application, verifying that the name of the application is on a list of unique package names in the protected storage;
and preventing the restricted system component from performing the function if the verification fails or permitting the restricted system component to perform the function if the verification succeeds.

13. A computer-implemented method performed by a data processing apparatus, the method comprising:
generating a public/private key pair comprising a public and private key, wherein the public key verifies a signature created using the private key;
generating a certificate comprising the signature created using the private key;
signing an application with the certificate;
sending the application to be installed on a mobile computing device; and
sending a copy of the public key to be stored in a protected storage of the mobile computing device.

14. The computer-implemented method of claim 13, wherein only an party that signs the application with the certificate has the ability to modify the protected storage of the mobile computing device.

15. The computer-implemented method of claim 13, further comprising:
generating a second public/private key pair comprising a second public and a second private key, wherein the second public key verifies a second signature created using the second private key;
deleting the public key from the protected storage of the mobile computing device;
removing the certificate from the application;
generating a second certificate comprising the second signature;
signing the application with the second certificate to generate an updated application;
sending the updated application to the mobile computing device to replace the application; and
sending a copy of the second public key to the protected storage of the mobile computing device.

16. The computer-implemented method of claim 13, wherein the application includes at least one function that requires a system call to a restricted system component of the system of the mobile computing device.

17. The computer-implemented method of claim 13, wherein the application is not sent to the mobile computing device as part of a system build.

18. The computer-implemented method of claim 13, wherein public key is sent to the mobile computing device using an out-of-band over-the-air update.

19. A computer-implemented system for restricting mobile system calls comprising:
a storage;
a protected storage comprising a public key, and adapted to receive the public key from a remote computing device of a party that is authorized to modify data in the protected storage;
an application comprising a certificate, the certificate comprising a signature, the application adapted to make a system call to a restricted system component; and
a system comprising at least one restricted system component, the system adapted to receive a system call to the at least one restricted system component from the application, verify the signature of the certificate of the application with the public key, and permit the at least one restricted system component to perform a function indicated by the system call when the signature is successfully verified.

20. The computer-implemented system of claim 19, wherein the system is further adapted to prevent the at least one restricted system component from performing the function indicated by the system call when verification of the signature fails.

21. The computer-implemented system of claim 19, wherein the at least one restricted system component is a restricted API.

22. The computer-implemented system of claim 19, wherein the application is received from a remote computing device of the party that is authorized to modify data in the protected storage.

23. The computer-implemented system of claim 19, wherein the signature of the certificate of the application is created using a private key from a public/private key pair, and wherein the public key is from the same public/private key pair.

24. The computer-implemented system of claim 19, wherein the protected storage is further adapted to receive the public key as part of an out-of-band over-the-air update from the remote computing device.

25. The computer-implemented system of claim 19, wherein the system is further adapted to determine that the application has been granted permission to make the system call to the at least on restricted system component.

26. The computer-implemented system of claim 19, wherein the system call indicates a function that is one of modifying settings in the storage, erasing the storage, dialing an emergency number, or filtering an SMS message.

27. A system comprising: one or more computers and one or more storage devices storing instructions which are operable, when executed by the one or more computers, to cause the one or more computers to perform operations comprising:
receiving a system call to a restricted system component from an application;
determining that the application has permission to make the system call to the restricted system component;
verifying a signature associated with the application using a public key from a protected storage, wherein the public key was sent to the protected storage by a computing device of a party authorized to modify data in the protected storage; and
permitting the restricted system component to perform a function indicated by the system call when the public key successfully verifies the signature associated with application.
